(19) United States
(12) Patent Application Publication
(10) Pub. No.: US 2018/0082649 A1
(43) Pub. Date: Mar. 22, 2018

(54) DRIVER CIRCUIT OF LIQUID CRYSTAL DISPLAY PANEL AND LIQUID CRYSTAL DISPLAY PANEL

(71) Applicant: Shenzhen China Star Optoelectronics Technology Co. Ltd., Shenzhen (CN)

(72) Inventor: Wenying LI, Shenzhen (CN)

(21) Appl. No.: 15/323,491

(22) PCT Filed: Dec. 14, 2016
(86) PCT No.: PCT/CN2016/109863

§ 371 Date: Jan. 3, 2017

(30) Foreign Application Priority Data
Sep. 18, 2016 (CN) 201610828715.5

(51) Int. Cl. G09G 3/36; G09F 9/35; G09G 3/20

(52) U.S. Cl. CPC G09G 3/3614; G09G 3/36; G09G 2310/0289; G09G 3/3648; G09G 3/2011; G09F 9/35

(57) ABSTRACT

The present disclosure provides a driver circuit for driving a liquid crystal display (LCD) panel and an LCD. The driver circuit includes a gate driver on array (GOA) circuit configured to drive a scan line arranged in a display zone of the LCD panel based on clock control signals having a determined waveform which is a periodical square wave. A magnitude of a high voltage level of the determined waveform increases periodically, and a duration of each period of the determined waveform is constant. In this way, the LCD panel shows more evenly images with better quality.

### BACKGROUND

### 1. Field of the Disclosure

The present disclosure relates to the field of a liquid crystal display, and more particularly, to a driver circuit and a liquid crystal display (LCD) panel with the driver circuit.

### 2. Description of the Related Art

Flat display devices, such as liquid crystal displays (LCDs) have advantages of high-definition, energy-saving, thin body, wide applied field, and so on, so they are widely applied to various kinds of consumer electronics products, such as cellphones, televisions, personal digital assistants (PDAs), digital cameras, notebook computers, and laptop computers, and become the mainstream display devices. Conventionally, backlight LCDs are the mainstream products, including thin film transistor liquid crystal display (TFT-LCD) panels and backlight modules. The operating principle of a TFT-LCD panel is as follows: Liquid crystal molecules are inserted between two parallel glass substrates. Very small electrical wire is vertically and horizontally arranged between the parallel glass substrates. The alignment of the liquid crystal molecules is changed after being electrified. Afterwards, the light beams produced by the backlight modules are refracted so that images can be generated.

The tendency of panel driver technique which is widely adopted by a television (TV) LCD is the gate driver on array (GOA) technique. The GOA technique is a technique that a driver circuit of a horizontal scan line on a panel is formed on a substrate around the display zone panel based on the original manufacturing process for the flat LCD panel. With the GOA technique, the manufacturing process of the flat LCD panel is simplified. Also, the adhesion process in a direction of the horizontal scan line is omitted, which is good for enhancing productivity and lowering production cost. Also, the integrity of the LCD panel is improved to more satisfy the display products with a narrow bezel or no bezels to satisfy modern people. However, the GOA technique is restricted to the size of the LCD panel. The larger the LCD panel is, the more difficulty the GOA technique is applied. In other words, the display brightness of the LCD panel becomes more obviously from top to bottom after an input signal for driving the GOA of the LCD panel to operate from top to bottom passes through larger and larger electrical impedance. Besides, the LCD panel fails to adopt the GOA technique to drive if the brightness differs obviously.

FIG. 7 illustrates waveforms of the signals output by the GOA circuit controlled by two clock signals. FIG. 8 illustrates waveforms of the signals output by the GOA circuit controlled by four clock signals. The operating principle is as follows. The GOA circuit outputs a single-pulse signal with a width and voltage magnitude as the same as input clock signal according to the required timing of the panel. Pixels on a row turn on/off row by row according to the single-pulse signal. The operating principle for a plurality of clock control signals is the same as that for four clock signals.

The problem of the related art is as follows:

If the waveform applied to the GOA circuit in a display with a large size and a high resolution, electrical impedance on the bus gradually increases. Besides, the width of the GOA circuit cannot be too large when a narrow bezel is required, which means that the size of the TFT is restricted more seriously. At this time, a waveform of the output by the GOA circuit is lower than the high voltage level of the clock signal and has a waveform with a larger rising edge and a falling edge in the process of downlink. However, such a waveform implies that the driver ability of the pixel in the upper area of the LCD panel is inconsistent with the driver ability of the pixel in the lower area of the LCD panel. Furthermore, the GOA circuit fails to continue working normally, and inevitably the LCD panel cannot be driven. These problems need to be solved urgently.

### SUMMARY

An object of the present disclosure is to propose a driver circuit and an LCD panel with the driver circuit to solve the problem occurring in the related art. The problem is as follows: The display brightness of the LCD panel becomes more obviously from top to bottom after an input signal for driving the GOA of the LCD panel to operate from top to bottom passes through larger and larger electrical impedance. Besides, the LCD panel fails to adopt the GOA technique to drive if the brightness differs obviously.

According to the present disclosure, a driver circuit of a liquid crystal display (LCD) panel includes a gate driver on array (GOA) circuit, configured to drive a scan line arranged in a display zone of the LCD panel based on a plurality of clock control signals having a determined waveform which is a periodical square wave. A magnitude of a high voltage level of the determined waveform increases periodically, and a duration of each period of the determined waveform is constant.

Optionally, a chamfered waveform for preventing wires from feeding through is applied between the high voltage level and a falling edge in each of the periods of the determined waveform.

Optionally, a high-voltage threshold of the high voltage level of the determined waveform is set, upon a condition that the magnitude of the high voltage level in one of the periods of the determined waveform surpasses the high-voltage threshold, the high voltage level with an initial magnitude of the clock control signal is outputted in the next period.

Optionally, a magnitude and width of the high voltage level of the determined waveform increase periodically, and a duration of each period of the determined waveform is constant.

Optionally, a chamfered waveform for preventing wires from feeding through is applied between the high voltage level and a falling edge in each of the periods of the determined waveform.

Optionally, a high-voltage threshold and a threshold of the width of the high voltage level of the determined waveform are set. Upon a condition that the magnitude of the high voltage level in one of the periods of the determined waveform surpasses the high-voltage threshold, or upon a condition that the width of the high voltage level of the determined waveform in one of the periods of the determined waveform surpasses the threshold of the width of the high voltage level of the determined waveform, the high voltage level with an initial magnitude and an initial width of the high voltage level of the clock control signal is outputted in the next period.

Optionally, the number of the clock control signals is four.

According to the present disclosure, a driver circuit of a liquid crystal display (LCD) panel includes a gate driver on array (GOA) circuit, configured to drive a scan line arranged in a display zone of the LCD panel based on a plurality of clock control signals having a determined waveform which is a periodical square wave. A width of a high voltage level of the determined waveform increases periodically, and a duration of each period of the determined waveform is constant.

Optionally, a chamfered waveform for preventing wires from feeding through is applied between the high voltage level and a falling edge in each of the periods of the determined waveform.

Optionally, a threshold of the width of the high voltage level of the determined waveform is set. Upon a condition that the width of the high voltage level of the determined waveform in one of the periods of the determined waveform surpasses the threshold of the width of the high voltage level of the determined waveform, the high voltage level with an initial width of the high voltage level of the clock control signal is outputted in the next period.

Optionally, the number of the clock control signals is four.

According to the present disclosure, a liquid crystal display (LCD) includes an LCD panel and a driver circuit. The driver circuit includes a gate driver on array (GOA) circuit, configured to drive a scan line arranged in a display zone of the LCD panel based on a plurality of clock control signals having a determined waveform which is a periodical square wave. A magnitude of a high voltage level of the determined waveform increases periodically, and a duration of each period of the determined waveform is constant.

Optionally, a chamfered waveform for preventing wires from feeding through is applied between the high voltage level and a falling edge in each of the periods of the determined waveform.

Optionally, a high-voltage threshold of the high voltage level of the determined waveform is set. Upon a condition that the magnitude of the high voltage level in one of the periods of the determined waveform surpasses the high-voltage threshold, the high voltage level with an initial magnitude of the clock control signal is outputted in the next period.

Optionally, a magnitude and width of the high voltage level of the determined waveform increase periodically, and a duration of each period of the determined waveform is constant.

Optionally, a chamfered waveform for preventing wires from feeding through is applied between the high voltage level and a falling edge in each of the periods of the determined waveform.

Optionally, a high-voltage threshold and a threshold of the width of the high voltage level of the determined waveform are set. Upon a condition that the magnitude of the high voltage level in one of the periods of the determined waveform surpasses the high-voltage threshold, or upon a condition that the width of the high voltage level of the determined waveform in one of the periods of the determined waveform surpasses the threshold of the width of the high voltage level of the determined waveform, the high voltage level with an initial magnitude and an initial width of the high voltage level of the clock control signal is outputted in the next period.

Optionally, the number of the clock control signals is four.

The beneficial effects of the present disclosure are:

The present disclosures propose an output waveform of the clock control signal outputted by the driver circuit is a determined waveform, which is good for increasingly enlarging the magnitude and/or the width of high voltage level of the determined waveform. Also, a chamfered waveform for preventing wires from feeding through is installed on the determined waveform so as to compensate for the energy lost after the clock control signal passes electrical impedance while the design of the entire GOA circuit is not affected. The required waveform of the signal is output easily and conveniently. Further, the problem that the display brightness of a place away from the driver terminal is darker than the display brightness of a place near the driver terminal is solved. In this way, the LCD panel shows more evenly images with better quality.

### BRIEF DESCRIPTION OF THE DRAWINGS

FIG. 1 illustrates determined waveforms according to a first embodiment of the present disclosure.

FIG. 2 illustrates determined chamfered waveform according to the first embodiment of the present disclosure.

FIG. 3 illustrates determined waveforms according to a second embodiment of the present disclosure.

FIG. 4 illustrates determined chamfered waveform according to the second embodiment of the present disclosure.

FIG. 5 illustrates determined waveforms according to a third embodiment of the present disclosure.

FIG. 6 illustrates determined chamfered waveform according to the third embodiment of the present disclosure.

FIG. 7 illustrates waveforms of the signals output by the GOA circuit controlled by two clock signals.

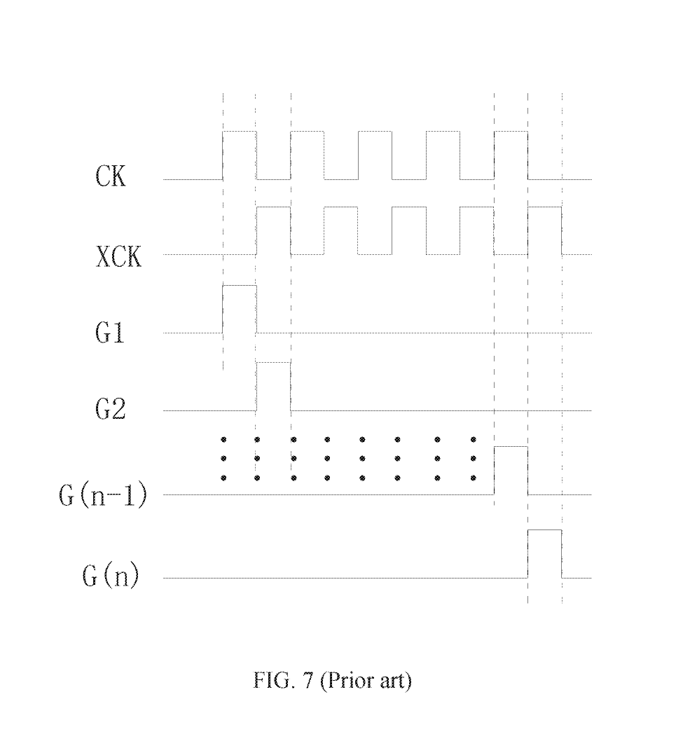

FIG. 8 illustrates waveforms of the signals output by the GOA circuit controlled by four clock signals.

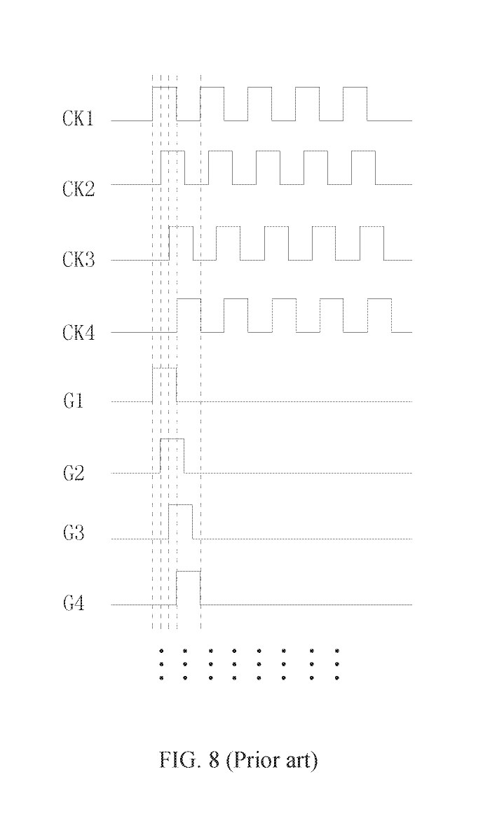

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

### Embodiment 1

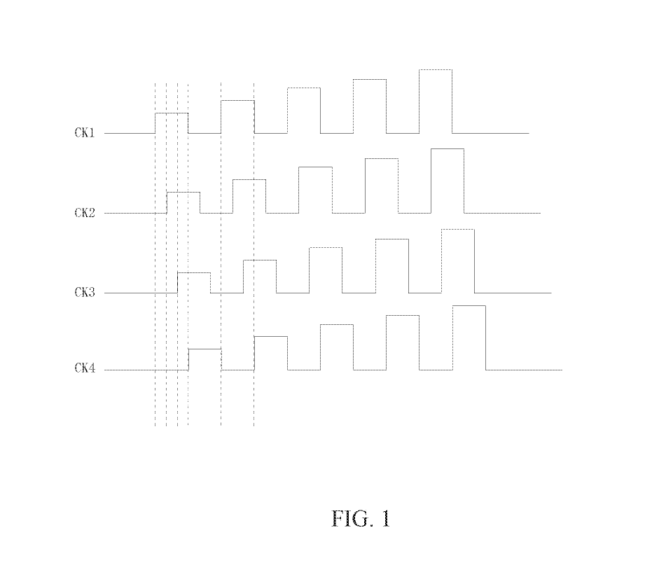

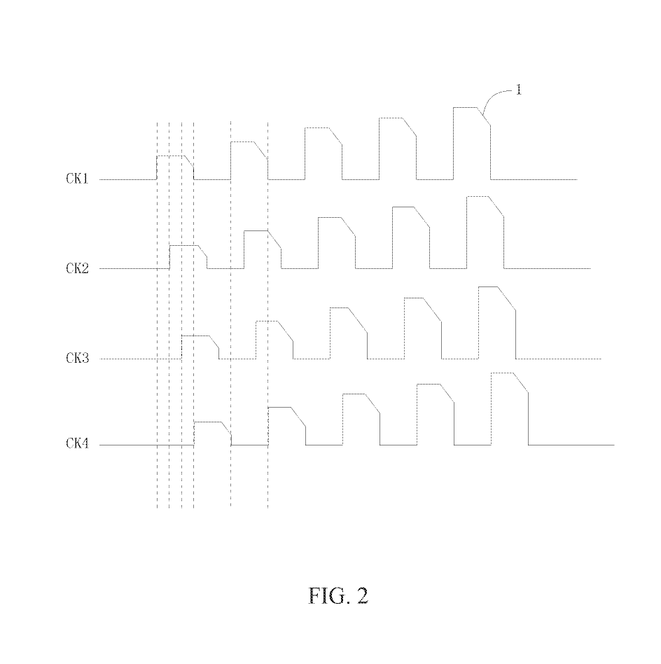

Please refer to FIG. 1 and FIG. 2. FIG. 1 illustrates determined waveforms according to a first embodiment of the present disclosure. FIG. 2 illustrates determined chamfered waveform 1 according to the first embodiment of the present disclosure.

The driver circuit in the LCD panel is used to output a plurality of clock control signals. After passing through the gate driver on array (GOA) circuit of the LCD panel, the plurality of clock control signals drive the scan lines arranged in the display zone of the LCD panel row by row. The driver circuit uses the clock control signal with a determined waveform. The determined waveform is a periodical square wave. A magnitude of the high voltage level of the determined waveform increases periodically, and the duration of each period of the determined waveform is the same.

A plurality of clock control signals are used. Preferably, four clock control signals CK1, CK2, CK3, and CK4 are used and shown in FIG. 1 and FIG. 2.

In this embodiment, the chamfered waveform 1 for preventing wires from feeding through is applied between the high voltage level and the falling edge in each period of the determined waveform. The chamfered waveform 1 prevents the clock control signals from a drop from the high voltage level to the low voltage level, resulting in a “feed through” condition for the wires.

In this embodiment, a high-voltage threshold is set for the determined waveform. When the magnitude of the high voltage level in one of the periods of the determined waveform surpasses the high-voltage threshold, the clock control signal outputs the high voltage level with the initial magnitude in the next period, i.e. the minimum high voltage level in the previous periods. Afterwards, the output routine repeats. It is because the magnitude of the high voltage level cannot be an extremely large value; instead, the magnitude is restricted to a certain range. The high-voltage threshold is determined by the designer.

The embodiment proposes an output waveform of the clock control signal outputted by the driver circuit is a determined waveform, which is good for increasingly enlarging the magnitude of high voltage level of the determined waveform. Also, a chamfered waveform for preventing wires from feeding through is installed on the determined waveform so as to compensate for the energy lost after the clock control signal passes electrical impedance while the design of the entire GOA circuit is not affected. The required waveform of the signal is output easily and conveniently. Further, the problem that the display brightness of a place away from the driver terminal is darker than the display brightness of a place near the driver terminal is solved. In this way, the LCD panel shows more evenly images with better quality.

### Embodiment 2

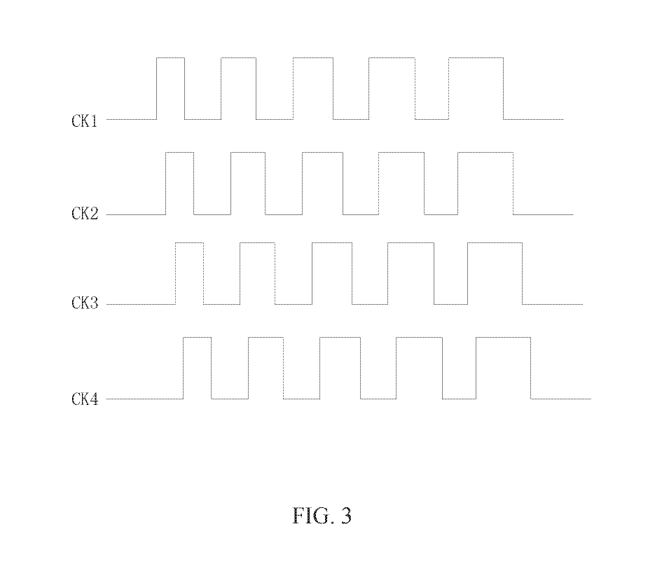

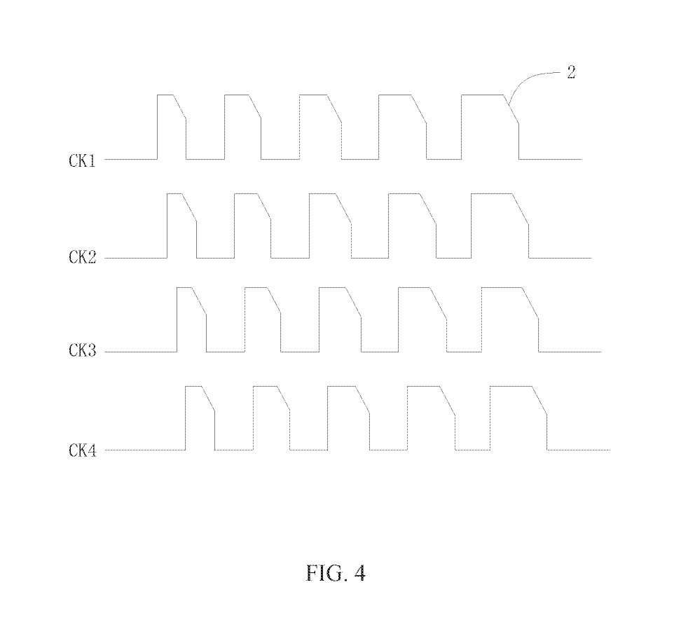

Please refer to FIG. 3 and FIG. 4. FIG. 3 illustrates determined waveforms according to a second embodiment of the present disclosure. FIG. 4 illustrates determined chamfered waveform 2 according to the second embodiment of the present disclosure.

The driver circuit in the LCD panel is used to output a plurality of clock control signals. After passing through the gate driver on array (GOA) circuit of the LCD panel, the plurality of clock control signals drive the scan lines arranged in the display zone of the LCD panel row by row. The driver circuit uses the clock control signal with a determined waveform. The determined waveform is a periodical square wave. The width of the high voltage level of the determined waveform increases periodically, and the duration of each period of the determined waveform is the same.

A plurality of clock control signals are used. Preferably, four clock control signals CK1, CK2, CK3, and CK4 are used and shown in FIG. 3 and FIG. 4.

In this embodiment, the chamfered waveform 2 for preventing wires from feeding through is applied between the high voltage level and the falling edge in each period of the determined waveform. The chamfered waveform 2 prevents the clock control signals from a drop from the high voltage level to the low voltage level, resulting in a “feed through” condition for the wires.

In this embodiment, a threshold of the width of the high voltage level of the determined waveform is set. When the width of the high voltage level of the determined waveform in one of the periods of the determined waveform surpasses the threshold of the width of the high voltage level of the determined waveform, the clock control signal outputs the initial width of the high voltage level in the next period, i.e. the minimum width of the high voltage level in the previous periods. Afterwards, the output routine repeats. It is because the width of the high voltage level of the determined waveform cannot be an extremely large value; instead, the width of the high voltage level of the determined waveform is restricted to a certain range. The threshold of the width of the high voltage level of the determined waveform is determined by the designer.

The embodiment proposes an output waveform of the clock control signal outputted by the driver circuit is a determined waveform, which is good for increasingly enlarging the high voltage level. Also, a chamfered waveform for preventing wires from feeding through is installed on the determined waveform so as to compensate for the energy lost after the clock control signal passes electrical impedance while the design of the entire GOA circuit is not affected. The required waveform of the signal is output easily and conveniently. Further, the problem that the display brightness of a place away from the driver terminal is darker than the display brightness of a place near the driver terminal is solved. In this way, the LCD panel shows more evenly images with better quality.

### Embodiment 3

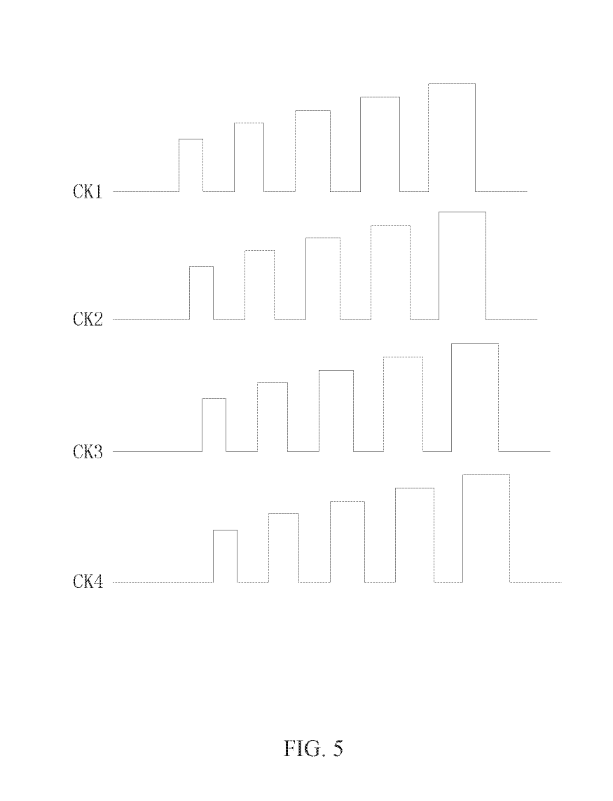

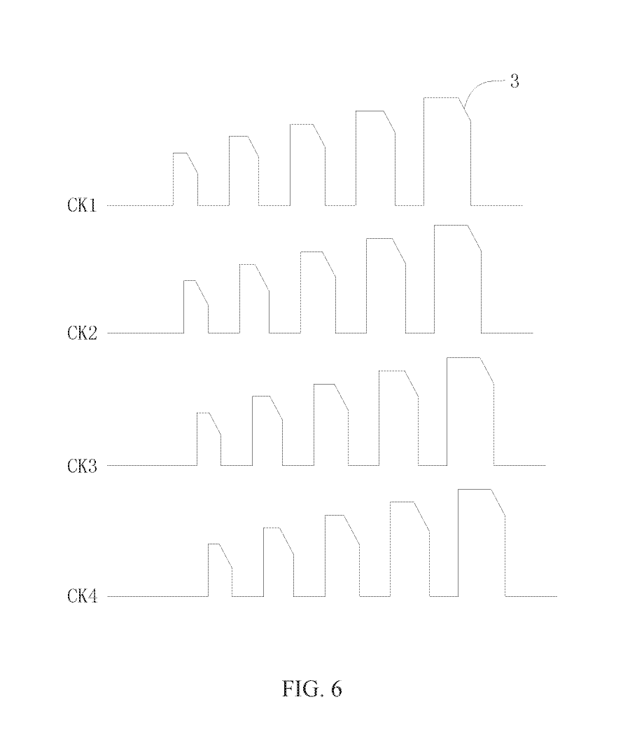

Please refer to FIG. 5 and FIG. 6. FIG. 5 illustrates determined waveforms according to a third embodiment of the present disclosure. FIG. 6 illustrates determined chamfered waveform 3 according to the third embodiment of the present disclosure.

The driver circuit in the LCD panel is used to output a plurality of clock control signals. After passing through the gate driver on array (GOA) circuit of the LCD panel, the plurality of clock control signals drive the scan lines arranged in the display zone of the LCD panel row by row. The driver circuit uses the clock control signal with a determined waveform. The determined waveform is a periodical square wave. The magnitude and width of the high voltage level of the determined waveform increase periodically, and the duration of each period of the determined waveform is the same.

A plurality of clock control signals are used. Preferably, four clock control signals CK1, CK2, CK3, and CK4 are used and shown in FIG. 5 and FIG. 6.

In this embodiment, the chamfered waveform 3 for preventing wires from feeding through is applied between the high voltage level and the falling edge in each period of the determined waveform. The chamfered waveform 3 prevents the clock control signals from a drop from the high voltage level to the low voltage level, resulting in a “feed through” condition for the wires.

In this embodiment, a high-voltage threshold and a threshold of the width of the high voltage level of the determined waveform are set. Upon a condition that the magnitude of the high voltage level in one of the periods of the determined waveform surpasses the high-voltage threshold, or upon a condition that the width of the high voltage level of the determined waveform in one of the periods of the determined waveform surpasses the threshold of the width of the high voltage level of the determined waveform, the clock control signal outputs the high voltage level with the initial magnitude (i.e. the minimum high voltage level in the previous periods) and the initial width of the high voltage level in the next period (i.e. the minimum width of the high voltage level in the previous periods). Afterwards, the output routine repeats. It is because the magnitude and width of the high voltage level of the determined waveform cannot be an extremely large value; instead, the magnitude and width of the high voltage level of the determined waveform is restricted to a certain range. The high-voltage threshold and threshold of the width of the high voltage level of the determined waveform are determined by the designer.

The driver circuit used in an LCD of the present embodiment proposes an output waveform of the clock control signal outputted by the driver circuit is a determined waveform, which is good for increasingly enlarging the magnitude and/or the width of high voltage level of the determined waveform. Also, a chamfered waveform for preventing wires from feeding through is installed on the determined waveform so as to compensate for the energy lost after the clock control signal passes electrical impedance while the design of the entire GOA circuit is not affected. The required waveform of the signal is output easily and conveniently. Further, the problem that the display brightness of a place away from the driver terminal is darker than the display brightness of a place near the driver terminal is solved. In this way, the LCD panel shows more evenly images with better quality.

### Embodiment 4

The LCD includes an LCD panel. The LCD panel includes the driver circuit introduced by each one of the embodiments. The driver circuit is detailed in all of the embodiments and will not be further detailed.

The LCD of the present embodiment proposes an output waveform of the clock control signal outputted by the driver circuit is a determined waveform, which is good for increasingly enlarging the magnitude and/or the width of high voltage level of the determined waveform. Also, a chamfered waveform for preventing wires from feeding through is installed on the determined waveform so as to compensate for the energy lost after the clock control signal passes electrical impedance while the design of the entire GOA circuit is not affected. The required waveform of the signal is output easily and conveniently. Further, the problem that the display brightness of a place away from the driver terminal is darker than the display brightness of a place near the driver terminal is solved. In this way, the LCD panel shows more evenly images with better quality.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A driver circuit of a liquid crystal display (LCD) panel, comprising:
a gate driver on array (GOA) circuit, configured to drive a scan line arranged in a display zone of the LCD panel based on a plurality of clock control signals having a determined waveform which is a periodical square wave,
wherein a magnitude of a high voltage level of the determined waveform increases periodically, and a duration of each period of the determined waveform is constant.

2. The driver circuit of claim 1, wherein a chamfered waveform for preventing wires from feeding through is applied between the high voltage level and a falling edge in each of the periods of the determined waveform.

3. The driver circuit of claim 1, wherein a high-voltage threshold of the high voltage level of the determined waveform is set; upon a condition that the magnitude of the high voltage level in one of the periods of the determined waveform surpasses the high-voltage threshold, the high voltage level with an initial magnitude of the clock control signal is outputted in the next period.

4. The driver circuit of claim 1, wherein a magnitude and width of the high voltage level of the determined waveform increase periodically, and a duration of each period of the determined waveform is constant.

5. The driver circuit of claim 4, wherein a chamfered waveform for preventing wires from feeding through is applied between the high voltage level and a falling edge in each of the periods of the determined waveform.

6. The driver circuit of claim 4, wherein a high-voltage threshold and a threshold of the width of the high voltage level of the determined waveform are set; upon a condition that the magnitude of the high voltage level in one of the periods of the determined waveform surpasses the high-voltage threshold, or upon a condition that the width of the high voltage level of the determined waveform in one of the periods of the determined waveform surpasses the threshold of the width of the high voltage level of the determined waveform, the high voltage level with an initial magnitude and an initial width of the high voltage level of the clock control signal is outputted in the next period.

7. The driver circuit of claim 1, wherein the number of the clock control signals is four.

8. A driver circuit of a liquid crystal display (LCD) panel, comprising:
a gate driver on array (GOA) circuit, configured to drive a scan line arranged in a display zone of the LCD panel based on a plurality of clock control signals having a determined waveform which is a periodical square wave,
wherein a width of a high voltage level of the determined waveform increases periodically, and a duration of each period of the determined waveform is constant.

9. The driver circuit of claim 8, wherein a chamfered waveform for preventing wires from feeding through is applied between the high voltage level and a falling edge in each of the periods of the determined waveform.

10. The driver circuit of claim 8, wherein a threshold of the width of the high voltage level of the determined waveform is set; upon a condition that the width of the high voltage level of the determined waveform in one of the periods of the determined waveform surpasses the threshold of the width of the high voltage level of the determined waveform, the high voltage level with an initial width of the high voltage level of the clock control signal is outputted in the next period.

11. The driver circuit of claim 8, wherein the number of the clock control signals is four.

12. A liquid crystal display (LCD) comprising an LCD panel and a driver circuit, the driver circuit comprising:
a gate driver on array (GOA) circuit, configured to drive a scan line arranged in a display zone of the LCD panel based on a plurality of clock control signals having a determined waveform which is a periodical square wave,
wherein a magnitude of a high voltage level of the determined waveform increases periodically, and a duration of each period of the determined waveform is constant.

13. The liquid crystal display of claim 12, wherein a chamfered waveform for preventing wires from feeding through is applied between the high voltage level and a falling edge in each of the periods of the determined waveform.

14. The liquid crystal display of claim 12, wherein a high-voltage threshold of the high voltage level of the determined waveform is set; upon a condition that the magnitude of the high voltage level in one of the periods of the determined waveform surpasses the high-voltage threshold, the high voltage level with an initial magnitude of the clock control signal is outputted in the next period.

15. The liquid crystal display of claim 12, wherein a magnitude and width of the high voltage level of the determined waveform increase periodically, and a duration of each period of the determined waveform is constant.

16. The liquid crystal display of claim 15, wherein a chamfered waveform for preventing wires from feeding through is applied between the high voltage level and a falling edge in each of the periods of the determined waveform.

17. The liquid crystal display of claim 15, wherein a high-voltage threshold and a threshold of the width of the high voltage level of the determined waveform are set; upon a condition that the magnitude of the high voltage level in one of the periods of the determined waveform surpasses the high-voltage threshold, or upon a condition that the width of the high voltage level of the determined waveform in one of the periods of the determined waveform surpasses the threshold of the width of the high voltage level of the determined waveform, the high voltage level with an initial magnitude and an initial width of the high voltage level of the clock control signal is outputted in the next period.

18. The liquid crystal display of claim 12, wherein the number of the clock control signals is four.
